(19) United States
(12) Patent Application Publication
(10) Pub. No.: US 2025/0392879 A1
(43) Pub. Date: Dec. 25, 2025

(54) METHOD AND SYSTEM FOR CONTROLLING SOUND FIELDS OF SPEAKER ARRAY

(71) Applicant: WISTRON CORPORATION, New Taipei City (TW)

(72) Inventors: Han Yi LIU, New Taipei City (TW); Chang Hsin LAI, New Taipei City (TW)

(73) Assignee: WISTRON CORPORATION, New Taipei City (TW)

(21) Appl. No.: 18/985,993

(22) Filed: Dec. 18, 2024

(30) Foreign Application Priority Data
Jun. 19, 2024 (TW) 113122654

(51) Int. Cl. H04S 7/00; G06T 7/70; H04R 5/02

(52) U.S. Cl. CPC H04S 7/303; G06T 7/70; H04R 5/02; G06T 2207/30201

(57) ABSTRACT

A method for controlling the sound field of speaker arrays is provided. The method includes obtaining a position of a listener and distance information between the position and one or more speaker arrays, wherein each of the one or more speaker arrays includes a plurality of speakers. The method includes obtaining a delay time that corresponds to each of the speakers based on the distance information. The method includes processing audio signals according to the delay times corresponding to the speakers and outputting the audio signals to the speaker arrays.

### CROSS-REFERENCE TO RELATED APPLICATIONS

This application claims the priority and benefit of Taiwan Patent Application No. 113122654, filed on Jun. 19, 2024, the disclosure of which is hereby incorporated in its entirety by reference herein.

### TECHNICAL FIELD

The present disclosure generally relates to the field of speaker array technologies. More specifically, aspects of the present disclosure relate to a method and a system for controlling the sound fields of speaker arrays.

### BACKGROUND

With the development of multimedia technology, categories of multimedia devices enable people to enjoy multimedia audio-visual functions are changing with each passing day. Generally, home theaters and sound bars use multiple speakers to provide users with stereo and surround sound effects in situations such as playing videos and playing games.

Since the positions of the speakers are fixed, the stereo and surround sound effects will be compromised or even disappear when the user moves. For example, in a typical stereo system with a speaker array, the relationship between the waveform and time of the audio signals played by the speaker array is as shown in FIG. 1. Speakers 1˜n play the audio signals at the same time. However, the sound transmitted by speakers farther away from the user may be heard slower by the user, resulting in the special sound field effect not being fully provided to the user, and the user experience will be negatively affected.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, a method and system for controlling the sound field of speaker arrays provided in the present disclosure adjust the time for each speaker to play the audio signal by calculating the delay time of each speaker in the speaker array transmitting the audio signal to the listener.

In an exemplary embodiment, a method for controlling the sound field of speaker arrays is provided. The method includes obtaining a position of a listener and distance information between the position and one or more speaker arrays, wherein each of the one or more speaker arrays includes a plurality of speakers. The method includes obtaining a delay time that corresponds to each of the speakers based on the distance information. The method includes processing audio signals according to the delay times corresponding to the speakers and outputting the audio signals to the speaker arrays.

In some embodiments, each of the speaker arrays is composed of the speakers aligned in a straight line at equal intervals.

In some embodiments, each of the speaker arrays is composed of the speakers aligned in a straight line at different intervals.

In some embodiments, the distance information includes the shortest distances between the remaining speakers except for a first speaker in any speaker array and a first straight line, and the first straight line is an extended straight line connecting the first speaker and the listener. The first speaker is a reference speaker located on the far left or far right in the speaker array.

In some embodiments, the delay times are obtained based on the shortest distances and sound speed.

In some embodiments, the delay time τ is expressed as follows:

$$τ = \frac{dist}{v}$$

wherein dist is the shortest distance, and v is the sound speed.

In some embodiments, the step of processing the audio signals according to the delay times further comprises adjusting the audio signals so that the speakers play their respective audio signals in advance of corresponding delay times.

In some embodiments, before obtaining the position and the distance information, the method further comprises receiving a facial image generated by a photography device, wherein the facial image comprises a face of the listener. The method further comprises obtaining the position of the listener based on the facial image.

In some embodiments, after receiving the facial image generated by the photography device, the method further comprises: determining whether the facial image comprises more than one person and selecting a first person who is closest to the photography device in the facial image as the listener when the facial image comprises more than one person.

In some embodiments, the photography device is arranged at an intermediate position of one of the one or more speaker arrays.

In an exemplary embodiment, a system for controlling the sound field of speaker arrays is provided. The system comprises one or more speaker arrays and a computing device. The computing device is coupled to the one or more speaker arrays. The computing device executes the following tasks. The following tasks comprise obtaining a position of a listener and distance information between the position and the one or more speaker arrays, wherein each of the one or more speaker arrays includes a plurality of speakers. The following tasks comprise obtaining a delay time that corresponds to each of the speakers based on the distance information. The following tasks comprise processing audio signals according to the delay times corresponding to the speakers and outputting the audio signals to the speaker arrays.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a diagram showing the relationship between the waveform and the time of the audio signal.

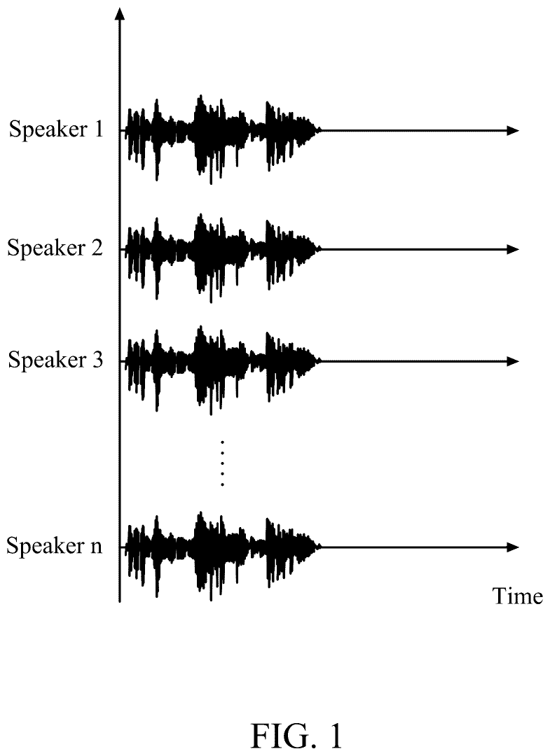

FIG. 2 shows an overhead view of a system for controlling the sound field of speaker arrays according to one embodiment of the disclosure.

FIG. 3 is a schematic diagram showing a system for controlling the sound field of speaker arrays including two speaker arrays according to an embodiment of the present disclosure.

FIG. 4 is a flowchart showing a method for obtaining a location of a listener according to an embodiment of the present disclosure.

FIG. 5 shows a schematic diagram of the distance and angle between the listener and the photography device according to an embodiment of the present disclosure.

FIG. 6 is a flowchart showing a method for controlling the sound field of speaker arrays according to an embodiment of the present disclosure.

FIG. 7 is a schematic diagram showing a listener and a speaker array according to an embodiment of the present disclosure.

FIG. 8 shows a schematic diagram of a listener, the first speaker array, and the second speaker array, according to an embodiment of the present disclosure.

FIG. 9 illustrates an exemplary operating environment for implementing embodiments of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

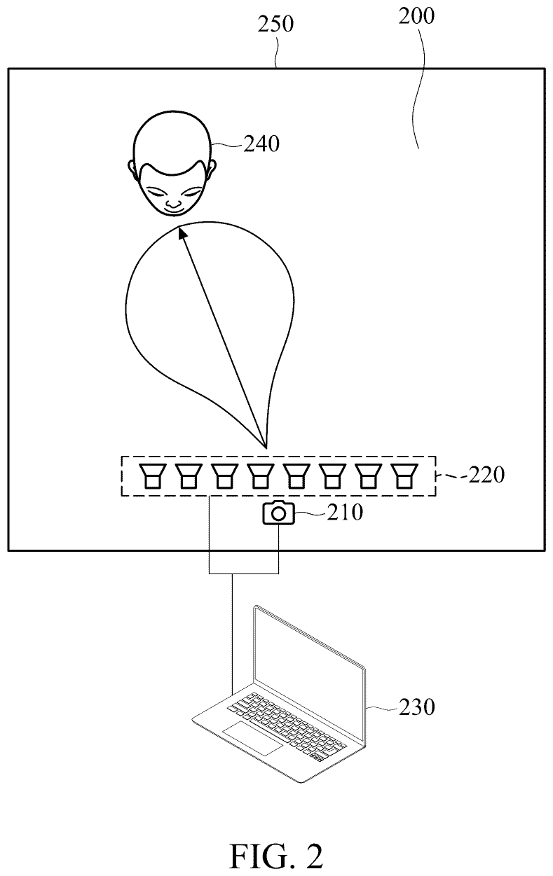

FIG. 2 shows an overhead view of a system 200 for controlling the sound field of speaker arrays according to one embodiment of the disclosure. The system 200 adjusts the time that the audio signal is played by each speaker in a speaker array 220 based on the location of one or more listeners 240 in a listening area 250. Each element of the system 200 for controlling the sound field of speaker arrays will be described by way of example below.

The system 200 for controlling a speaker array sound field may include a photography device 210, one or more speaker arrays 220, and a computing device 230, wherein the computing device 230 is coupled to the photography device 210 and one or more speaker arrays 220.

The photography device 210 is used to capture the face of the listener 240, wherein the photography device 210 may be a passive focusing camera, an active focusing camera, or a camera with depth perception. In one embodiment, the photography device 210 is arranged at the intermediate position of the speaker array 220. In yet another embodiment, the photography device 210 is arranged on the central vertical line of the speaker array 220.

The computing device 230 may be any device capable of processing one or more audio signals. For example, the computing device 230 in the system 200 of FIG. 2 is a laptop computer that processes one or more audio signals through a wired connection or a wireless connection. In other embodiments, the computing device 230 may instead be one or more of a desktop computer, a laptop computer, a tablet computer, a mobile device (e.g., a mobile phone or mobile music player), and a remote media server (e.g., an Internet streaming music or movie service), a set top box, a television, a game system, a personal video recorder, a DVD player, a Blu-Ray player, etc.

As shown in FIG. 2, the speaker array 220 receives one or more audio signals directly from the computing device 230 through a wired connection or a wireless connection. The speakers in the speaker array 220 may be any combination of full-range drivers, mid-range drivers, subwoofers, woofers, and tweeters. Each speaker may be individually and separately driven to produce sound in response to separate and discrete audio signals. By allowing the speakers in the speaker array 220 to be driven individually and separately based on different delay time settings.

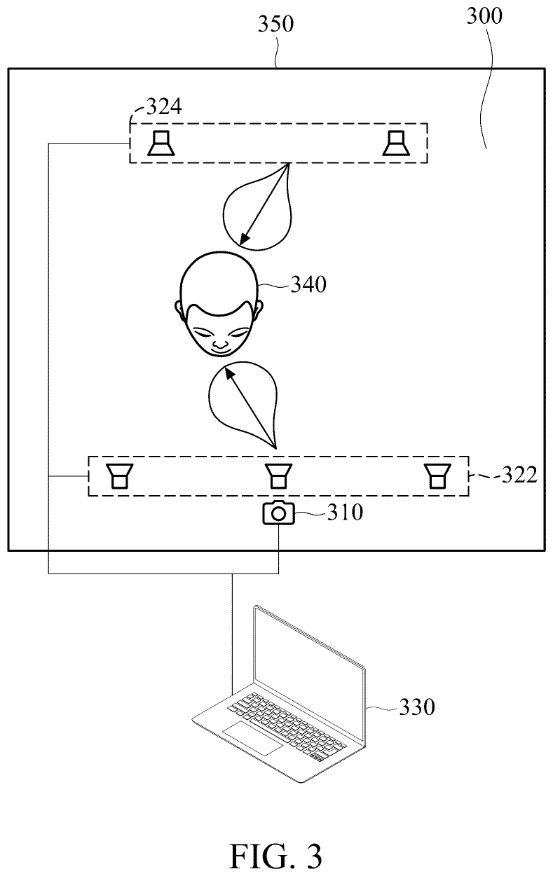

Although shown in FIG. 2 as including a single speaker array 220, the system 200 may include any number of speaker arrays 220 that are coupled to the computing device 230 through wired connections or wireless connections. For example, as shown in FIG. 3, the system 300 for controlling the sound field of speaker arrays may include two speaker arrays 322 and 324, which are disposed oppositely on both sides of a listening area 350. In one embodiment, each of the speaker arrays 322 and 324 is composed of a plurality of speakers aligned in a straight line at regular intervals or at irregular intervals. In another embodiment, the photography device 310 is arranged at a middle position of the speaker array 322 to capture the face of a listener 340. The speaker arrays 322 and 324 receive one or more audio signals directly from the computing device 330 through wired connections or wireless connections, and play the audio signals.

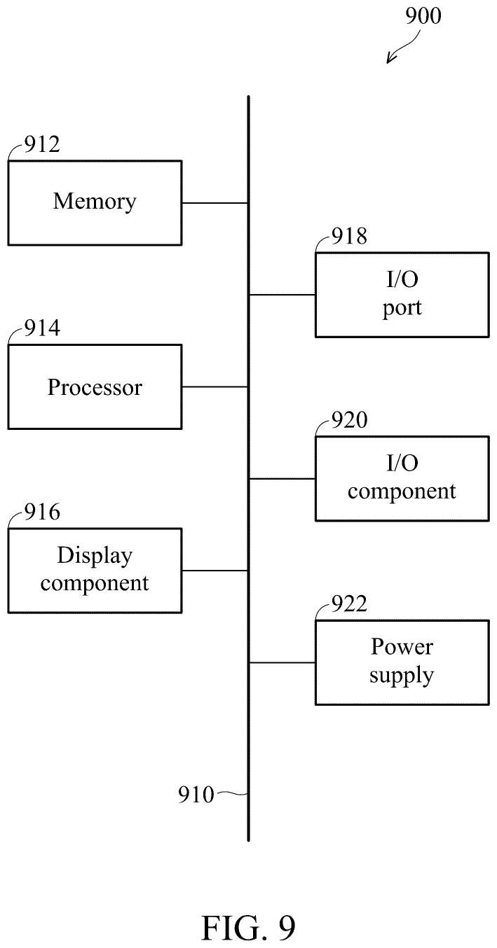

It should be understood that the computing device 230 and the computing device 330 shown in FIG. 2 and FIG. 3 are examples of the architecture of the system 200 and the system 300 for controlling the sound field of speaker arrays. The computing device 230 and the computing device 330 shown in FIG. 2 and FIG. 3 may be implemented through any type of computing device, such as the computing device 900 described with reference to FIG. 9, for example.

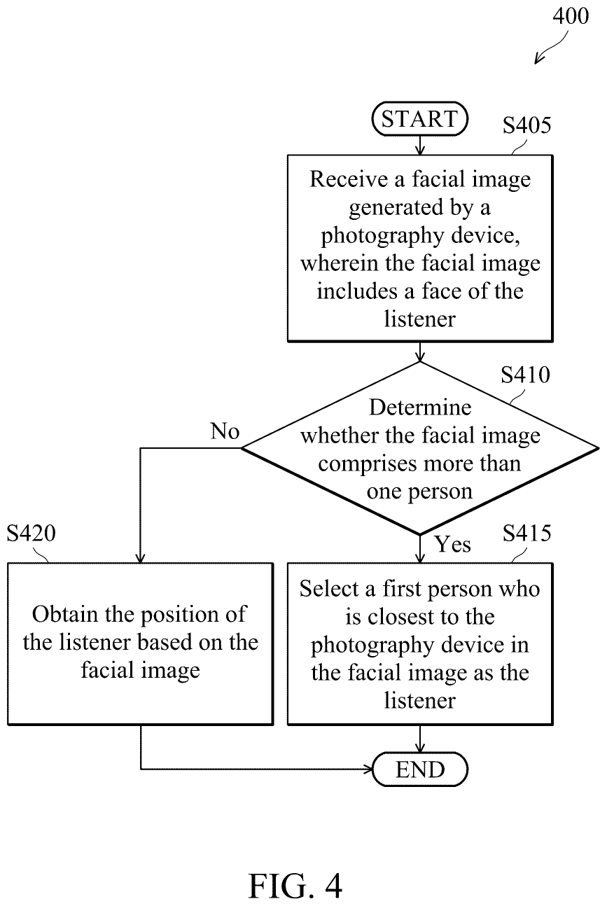

FIG. 4 is a flowchart showing a method 400 for obtaining a location of a listener according to an embodiment of the present disclosure. This method may be implemented by the computing device 230 and the computing device 330 in FIG. 2 and FIG. 3.

In step S405, the computing device receives a facial image generated by a photography device, wherein the facial image includes a face of the listener.

In step S410, the computing device determines whether the facial image comprises more than one person.

When the facial image comprises more than one person (“Yes” in step S410), in step S415, the computing device selects a first person who is closest to the photography device in the facial image as the listener. In other words, when there are multiple people in the listening area, the computing device selects the person who is closest to the photography device as the listener.

When the facial image comprises one person (“No” in step S410), in step S420, the computing device selects the person in the facial image as the listener and obtains the position of the listener based on the facial image.

Specifically, the computing device may detect the relationship between the size of the listener's face in the facial image and the field of view (FOV) of the photography device through some facial recognition algorithms, such as Face Cascade Classifier, to calculate the actual distance between the listener and the photography device.

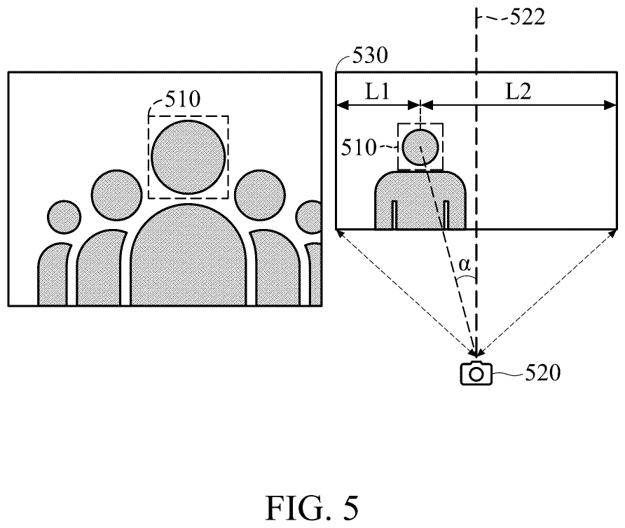

FIG. 5 shows a schematic diagram of the distance and angle between the listener and the photography device according to an embodiment of the present disclosure. As shown in FIG. 5, the computing device uses the face 510 closest to the photography device 520 as a reference to calculate the distance and angle between the listener and the photography device 520. Since the visual range 530 of the photography device 520 is fixed and known, the angle α of the face 510 relative to the central axis 522 of the lens of the photography device 520 can be calculated through the ratio L1:L2. The computing device may obtain the listener's position based on the angle α and the ratio L1:L2.

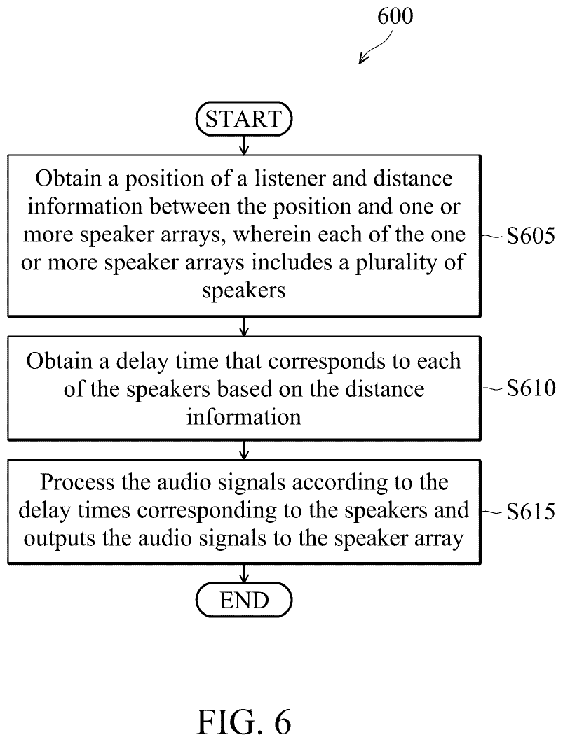

FIG. 6 is a flowchart showing a method 600 for controlling the sound field of speaker arrays according to an embodiment of the present disclosure. This method may be implemented by the computing device 230 and the computing device 330 in FIG. 2 and FIG. 3.

In step S605, the computing device obtains a position of a listener and distance information between the position and one or more speaker arrays, wherein each of the one or more speaker arrays includes a plurality of speakers. In one embodiment, each speaker array is composed of a plurality of speakers aligned in a straight line at regular intervals or at irregular intervals. In another embodiment, the distance information includes the shortest distances between the remaining speakers except for the first speaker in any speaker array and a first straight line, and the first straight line is an extended straight line connecting the first speaker and the listener, wherein the first speaker is a reference speaker located on the far left or far right in the speaker array.

In step S610, the computing device obtains a delay time that corresponds to each of the speakers based on the distance information, wherein the delay times of the speakers are obtained based on the shortest distances and the sound speed.

In step S615, the computing device processes the audio signals according to a delay times corresponding to the speakers and outputs the audio signals to the speaker array. In one embodiment, the computing device adjusts the audio signals so that each of the speakers plays its respective audio signal ahead of the corresponding delay time.

The following will describe in detail how the computing device obtains the distance information between a listener's position and one or more speaker arrays in step S605 and obtains a delay time corresponding to each speaker in step S610.

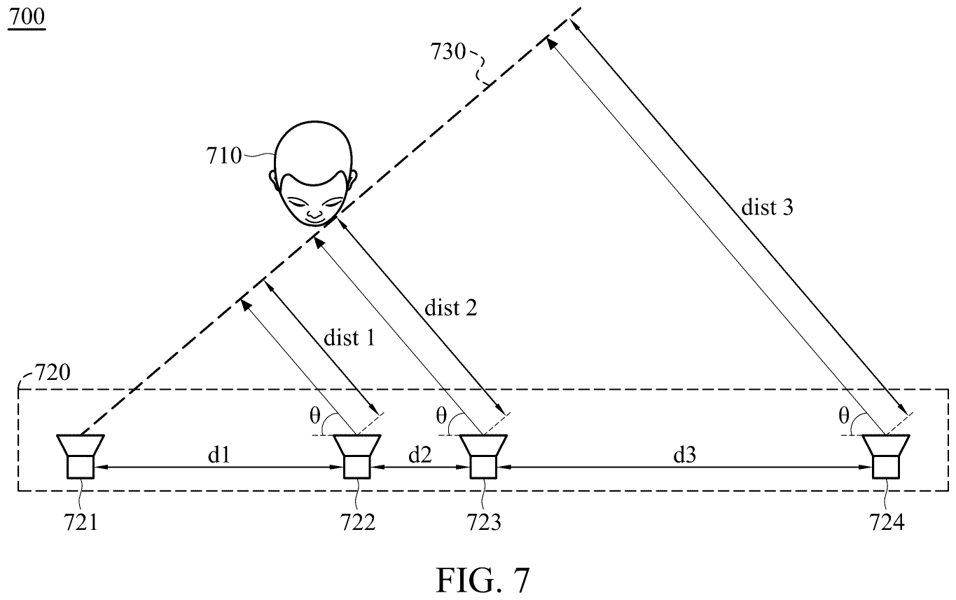

FIG. 7 is a schematic diagram 700 showing a listener 710 and a speaker array 720 according to an embodiment of the present disclosure. As shown in FIG. 7, the speaker array comprises speakers 721 to 724, and the speakers 721 to 724 are arranged in a straight line at different intervals d1 to d3. In this embodiment, using the speaker 721 as the reference speaker, the computing device may obtain the position of the listener through the method in FIG. 4 to derive the angle θ and the shortest distances dist 1, dist 2 and dist 3 from the speakers 722 to 724 to a straight line 730, wherein the straight line 730 is an extended straight line connecting the speaker 721 and the listener 710. The delay time 11˜13 for the speakers 722˜724 to transmit the audio signals to the listener 710 can be expressed by the following formula (1) and formula (2):

$${τ}_{n} = \frac{dist n}{v} \qquad ( 1 )$$

$$dist n = ( {\sum }_{i = 1}^{n} {d}_{i} ) \times cos θ \qquad ( 2 )$$

wherein dist is the shortest distance, v is the speed of sound that is 343.3 meters/second, and n is 1 to 3. Therefore, the speakers 722 to 724 may play the audio signals in advance of the delay time τ_1 to τ_3 respectively, so that the listener may obtain the best experience.

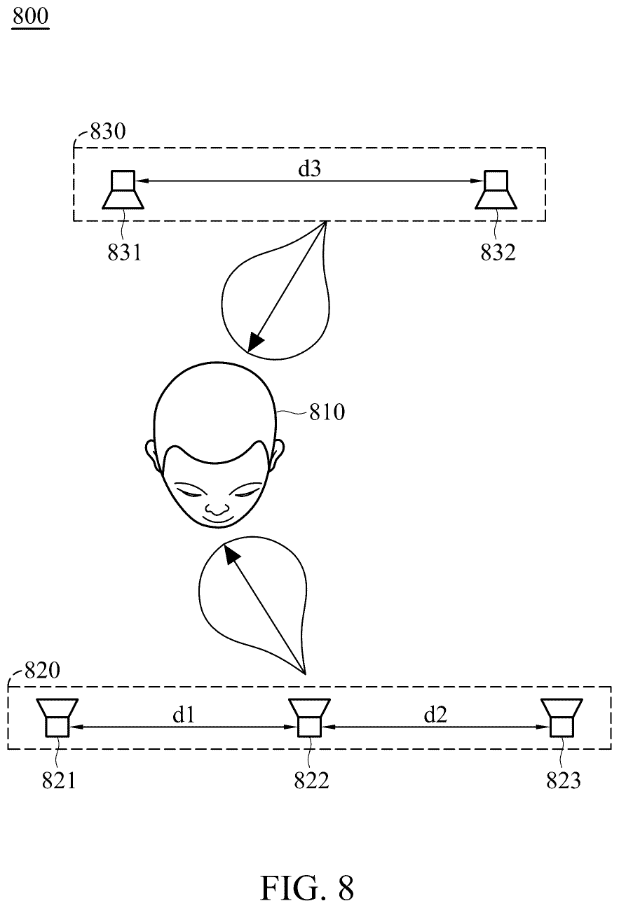

In another example, FIG. 8 shows a schematic diagram 800 of a listener 810, the first speaker array 820, and the second speaker array 830, according to an embodiment of the present disclosure. As shown in FIG. 8, the first speaker array 820 comprises speakers 821 to 823, and the speakers 821 to 823 are arranged in a straight line with different intervals d1 and d2. The second speaker array 830 comprises speakers 831 and 832, and the speakers 831 and 832 are arranged in a straight line with an interval d3. In the first speaker array 820, the speaker 821 is used as a reference speaker, and in the second speaker array 830, the speaker 831 is used as a reference speaker. The delay times of the speakers 822 and 823 in the first speaker array 820 and the delay time of the speaker 832 in the second speaker array 820 can be derived through the above formulas (1) and (2).

It should be noted that the number of speakers and the position of the reference speaker in FIG. 7 and FIG. 8 are not intended to limit the present disclosure, and those skilled in the art can make appropriate replacements or adjustments according to this embodiment. For example, the computing device may use the leftmost or rightmost speaker in the speaker array as the reference speaker.

The method and system for controlling the sound field of speaker arrays of the present disclosure can be applied to notebook computers, sound bars, smart home appliances or home theaters. When the speaker array is installed in a laptop, sound bar, or smart home appliance, the spacing of the speakers in the speaker array is fixed and known. When the speaker array is a speaker array in a home theater, the user first needs to input the spacing of the speakers in the speaker array into the computing device. Then, the computing device calculates the delay times through formula (1) and formula (2) and processes the audio signals. The computing device outputs the audio signals to the speaker array for playing the audio signals to achieve the purpose of providing the best sound effects to the listener.

Having described embodiments of the present disclosure, an exemplary operating environment in which embodiments of the present disclosure may be implemented is described below. Referring to FIG. 9, an exemplary operating environment for implementing embodiments of the present disclosure is shown and generally known as a computing device 900. The computing device 900 is merely an example of a suitable computing environment and is not intended to limit the scope of use or functionality of the disclosure. Neither should the computing device 900 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 9, the computing device 900 may include a bus 910 that is directly or indirectly coupled to the following devices: one or more memories 912, one or more processors 914, one or more display components 916, one or more input/output (I/O) ports 918, one or more input/output components 920, and an illustrative power supply 922. The bus 910 may represent one or more kinds of busses (such as an address bus, data bus, or any combination thereof). Although the various blocks of FIG. 9 are shown with lines for the sake of clarity, and in reality, the boundaries of the various components are not specific. For example, the display component such as a display device may be considered an I/O component and the processor may include a memory.

The computing device 900 typically includes a variety of computer-readable media. The computer-readable media can be any available media that can be accessed by computing device 900 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the computing device 900. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 912 may include computer-storage media in the form of volatile and/or nonvolatile memory. The memory may be removable, non-removable, or a combination thereof. Exemplary hardware devices include solid-state memory, hard drives, optical-disc drives, etc. The computing device 900 includes one or more processors that read data from various entities such as the memory 912 or the I/O components 920. The display component(s) 916 present data indications to a user or to another device. Exemplary presentation components include a display device, speaker, printing component, vibrating component, etc.

The I/O ports 918 allow the electronic device 900 to be logically coupled to other devices including the I/O components 920, some of which may be embedded. Illustrative components include a microphone, joystick, game pad, satellite dish, scanner, printer, wireless device, etc. The I/O components 920 may provide a natural user interface (NUI) that processes gestures, voice, or other physiological inputs generated by a user. For example, inputs may be transmitted to an appropriate network element for further processing. The computing device 900 may be equipped with depth cameras, such as stereoscopic camera systems, infrared camera systems, RGB camera systems, or any combination thereof, to detect and identify objects. In addition, the computing device 900 may be equipped with sensors (e.g., radar, lidar) to periodically sense the surrounding environment within a sensing range and generate sensor information representing the relationship between the computing device 900 and the surrounding environment. Furthermore, the computing device 900 may be equipped with accelerometers or gyroscopes that enable detection of motion. The output of the accelerometers or gyroscopes may be provided to the computing device 900 for display.

Furthermore, the processor 914 in the computing device 900 can execute the program code in the memory 912 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

Accordingly, the method and system of this disclosure control the sound fields of speaker arrays, so that the sound effect can be automatically adjusted according to the user's position, enhancing the user experience for better enjoyment.

What is claimed is:

1. A method for controlling a sound field of speaker arrays, used in a device, the method comprising:
obtaining a position of a listener and distance information between the position and one or more speaker arrays, wherein each of the one or more speaker arrays includes a plurality of speakers;
obtaining a delay time that corresponds to each of the plurality of speakers based on the distance information; and
processing each of a plurality of audio signals according to the delay times corresponding to each of the plurality of speakers and outputting the plurality of audio signals to the one or more speaker arrays.

2. The method for controlling the sound field of speaker arrays of claim 1, wherein each of the one or more speaker arrays includes the plurality of speakers aligned in a straight line at equal intervals.

3. The method for controlling the sound field of speaker arrays of claim 1, wherein each of the one or more speaker arrays includes the plurality of speakers aligned in a straight line at different intervals.

4. The method for controlling the sound field of speaker arrays of claim 1, wherein the distance information includes a plurality of shortest distances between the remaining of the plurality of speakers except for a first speaker in any of the one or more speaker arrays and a first straight line, and the first straight line is an extended straight line connecting the first speaker and the listener; and
wherein the first speaker is a reference speaker located on the far left or far right in any of the one or more speaker arrays.

5. The method for controlling the sound field of speaker arrays of claim 4, wherein the delay time is obtained based on each of the plurality of shortest distances and sound speed.

6. The method for controlling the sound field of speaker arrays of claim 5, wherein the delay time τ is expressed as follows:
$$τ = \frac{dist}{v}$$
wherein dist is the shortest distance, and v is the sound speed.

7. The method for controlling the sound field of speaker arrays of claim 1, wherein the step of processing each of the plurality of audio signals according to the delay time further comprises:
adjusting each of the plurality of the audio signals so that each of the plurality of speakers plays their respective each of the plurality of the audio signals in advance of corresponding delay times.

8. The method for controlling the sound field of speaker arrays of claim 1, wherein before obtaining the position and the distance information, the method further comprises:
receiving a facial image generated by a photography device, wherein the facial image comprises a face of the listener; and
obtaining the position of the listener based on the facial image.

9. The method for controlling the sound field of speaker arrays of claim 8, wherein after receiving the facial image generated by the photography device, the method further comprises:
determining that the facial image comprises more than one person; and
selecting a first person who is closest to the photography device in the facial image as the listener.

10. The method for controlling the sound field of speaker arrays of claim 8, wherein the photography device is arranged at an intermediate position of one of the one or more speaker arrays.

11. A system for controlling a sound field of speaker arrays, comprising:
one or more speaker arrays; and
a computing device, coupled to the one or more speaker arrays;
wherein the computing device executes a plurality of following tasks:
obtaining a position of a listener and distance information between the position and the one or more speaker arrays, wherein each of the one or more speaker arrays includes a plurality of speakers;
obtaining a delay time that corresponds to each of the plurality of speakers based on the distance information; and
processing each of a plurality of audio signals according to the delay time corresponding to each of the plurality of speakers and outputting the plurality of audio signals to the one or more speaker arrays.

12. The system for controlling the sound field of speaker arrays of claim 11, wherein each of the one or more speaker arrays includes the plurality of speakers aligned in a straight line at regular intervals.

13. The system for controlling the sound field of speaker arrays of claim 11, wherein each of the one or more speaker arrays includes the plurality of speakers aligned in a straight line at irregular intervals.

14. The system for controlling the sound field of speaker arrays of claim 11, wherein the distance information includes a plurality of shortest distances between the remaining of the plurality of speakers except for a first speaker in any of the one or more speaker arrays and a first straight line, and the first straight line is an extended straight line connecting the first speaker and the listener; and
wherein the first speaker is a reference speaker located on the far left or far right in any of the one or more speaker arrays.

15. The system for controlling the sound field of speaker arrays of claim 14, wherein the delay time is obtained based on each of the plurality of shortest distances and sound speed.

16. The system for controlling the sound field of speaker arrays of claim 15, wherein the delay time τ is expressed as follows:
$$τ = \frac{dist}{v}$$
wherein dist is the shortest distance, and v is the sound speed.

17. The system for controlling the sound field of speaker arrays of claim 11, wherein the step of processing each of the plurality of audio signals according to the delay time further comprises:
adjusting each of the plurality of audio signals so that each of the plurality of speakers plays their respective each of the plurality of audio signals in advance of corresponding delay times.

18. The system for controlling the sound field of speaker arrays of claim 11, further comprising:
a photography device, coupled to the computing device;
wherein before the computing device obtains the position and the distance information, the computing device further executes the plurality of following tasks:
receiving a facial image generated by the photography device, wherein the facial image comprises a face of the listener; and
obtaining the position of the listener based on the facial image.

19. The system for controlling the sound field of speaker arrays of claim 18, wherein after receiving the facial image generated by the photography device, the computing device further executes the plurality of following tasks:
determining that the facial image comprises more than one person; and
selecting a first person who is closest to the photography device in the facial image as the listener.

20. The system for controlling the sound field of speaker arrays of claim 18, wherein the photography device is arranged at an intermediate position of one of the one or more speaker arrays.
